(19) United States
(12) Patent Application Publication
(10) Pub. No.: US 2025/0285384 A1
(43) Pub. Date: Sep. 11, 2025

(54) METHOD FOR PLACING VIRTUAL OBJECT IN VIDEO AND RELATED DEVICE

(71) Applicant: Beijing Zitiao Network Technology Co., Ltd., Beijing (CN)

(72) Inventors: Hengkai Guo, Beijing (CN); Jiawei Wen, Beijing (CN)

(21) Appl. No.: 18/851,040

(22) PCT Filed: Mar. 3, 2023
(86) PCT No.: PCT/CN2023/079649

§ 371 Date: Sep. 25, 2024

(30) Foreign Application Priority Data
Mar. 25, 2022 (CN) 202210306832.0

(51) Int. Cl. G06T 19/00; G06T 15/06; G06T 17/20; G06T 19/20

(52) U.S. Cl. CPC G06T 19/006; G06T 15/06; G06T 17/20; G06T 19/20; G06T 2210/21; G06T 2210/56; G06T 2219/008; G06T 2219/2004

(57) ABSTRACT

Provided is a method for placing a virtual object in a video. The method comprises: obtaining a three-dimensional (3D) point cloud corresponding to a video; for each image frame in the video, obtaining 3D points in the 3D point cloud having corresponding two-dimensional (2D) points in the image frame; obtaining a grid by means of triangulation based on the 3D points; determining a target position of the virtual object in the image frame according to a placement position of the virtual object in the video and the grid; and placing the virtual object on a target location in the image frame. Based on the foregoing method for placing a virtual object in a video, the present disclosure further provides an apparatus, an electronic device, a storage medium, and a program product for placing a virtual object in a video.

This application claims priority to Chinese Patent Application No. CN202210306832.0, filed on Mar. 25, 2022, entitled ‘METHOD FOR PLACING VIRTUAL OBJECT IN VIDEO AND RELATED DEVICE’, which is incorporated herein by reference.

### FIELD

The present disclosure relates to the field of computer vision technologies, and in particular, to a method, an apparatus, an electronic device, a storage medium, and a program product for placing a virtual object in a video.

### BACKGROUND

Augmented Reality (AR) technology is a technology for merging virtual information with a real world. The technology widely applies a plurality of technical means such as multimedia, three-dimensional modeling, real-time tracking, intelligent interaction and sensing, etc., and after simulating virtual objects such as text, images, three-dimensional models, music and videos generated by a computer, the technology is applied to the real world so as to realize “enhancement” of the real world.

Currently, three-dimensional modeling may be generally implemented by using a simultaneous localization and mapping (SLAM) technology. However, as the three-dimensional (3D) points obtained by the SLAM technique are generally sparse, there will be a relatively large number of planes that are not estimated due to fewer 3D points. In addition, many non-planar areas in an actual scenario cannot be estimated by using the SLAM technology. Because a virtual object in the AR can only be placed on an estimated plane generally, existence of the foregoing cases causes a problem that the virtual object cannot be placed in an image or a video because a plane corresponding to the virtual object cannot be found.

### SUMMARY

In view of this, embodiments of the present disclosure provide a method for placing a virtual object in a video. A plane for placing a virtual object can be accurately determined in a video, and accurate placement of the virtual object is completed, thereby avoiding the problem that a virtual object cannot be placed in an image because a plane corresponding to the virtual object cannot be found.

According to some embodiments of the present disclosure, the above method for placing a virtual object in a video may comprise: obtaining a 3D point cloud corresponding to the video; for each image frame in the video, respectively obtaining a 3D point in the 3D point cloud having a corresponding two-dimensional 2D point in the image frame; obtaining a grid through triangulation based on the 3D point; determining a target location of the virtual object in the image frame according to a placement location of the virtual object in the video and the grid; and placing the virtual object on a target location in the image frame.

Based on the described method for placing a virtual object in a video, an embodiment of the present disclosure provides an apparatus for placing a virtual object in a video, comprising:
a three-dimensional 3D point cloud obtaining module, configured to obtain a 3D point cloud corresponding to the video;
a triangulation module, configured to, obtain, for each image frame in a video, a 3D point in the 3D point cloud having a corresponding two-dimensional 2D point in the image frame, and obtain a grid through triangulation based on the 3D point;
a target position determination module, configured to determine a target location of the virtual object in the image frame according to a placement location of the virtual object in the video and the grid; and
a virtual object placing module, configured to place the virtual object on a target location in the image frame.

In addition, the embodiments of the present disclosure also provide an electronic device, comprising a memory, a processor and a computer program stored in the memory and executable on the processor, wherein the processor implements the described method when executing the program.

Embodiments of the present disclosure further provide a non-transitory computer-readable storage medium. The non-transitory computer-readable storage medium stores a computer instruction, where the computer instruction is used to enable a computer to execute the foregoing method.

Embodiments of the present disclosure also provide a computer program product, comprising computer program instructions, wherein when the computer program instructions run on a computer, the computer is enabled to execute the described method.

It can be seen from the described contents that, by means of the method and apparatus for placing a virtual object in a video provided in the present disclosure, a plurality of triangles with 3D points as their vertices may be obtained by means of triangulation, and each triangle may determine a plane. Therefore, a plurality of planes included in each image frame may be obtained according to the plurality of triangles, and then a target plane and a target location for the placement of the virtual object are determined therefrom according to the relationship between the placement position of the virtual object and the plurality of planes. The above-mentioned method may effectively solve the problem that placement of a virtual object cannot be completed due to the failure of the plane estimation when the plane estimation is performed based on a relatively small number of 3D points and some non-planar areas in an actual scene cannot be estimated.

### BRIEF DESCRIPTION OF THE DRAWINGS

To describe the technical solutions in the present disclosure or the related art more clearly, the following briefly introduces the accompanying drawings required for describing the embodiments or the related art. Apparently, the accompanying drawings in the following description show merely embodiments of the present disclosure, and a person of ordinary skill in the art may still derive other drawings from these accompanying drawings without creative efforts.

FIG. 1 is a schematic diagram of an application scenario of a method for placing a virtual object in a video according to an embodiment of the present disclosure;

FIG. 2 shows an implementation flow of a method for placing a virtual object in a video according to some embodiments of the present disclosure;

FIG. 3 shows an example of a grid obtained from a finite point set through a Delaunay triangulation algorithm according to an embodiment of the present disclosure;

FIG. 4 shows an implementation flow of determining a target position of the virtual object in the image frame according to the placement position of the virtual object in the video and the grid according to an embodiment of the present disclosure;

FIG. 5 shows a schematic diagram of an internal structure of an apparatus for placing a virtual object in a video according to some embodiments of the present disclosure;

FIG. 6 is a schematic diagram showing an internal structure of a target position determination module according to some embodiments of the present disclosure; and

FIG. 7 is a schematic structural diagram of more specific hardware of an electronic device according to an embodiment of the present invention.

### DETAILED DESCRIPTION

In order to make objects, technical solutions and advantages of the present disclosure more apparent, the present disclosure will be further described in detail below in conjunction with specific embodiments and with reference to the accompanying drawings.

It should be noted that, unless otherwise defined, technical terms or scientific terms used in the embodiments of the present disclosure should have a common meaning understood by those skilled in the art. The terms ‘first’, ‘second’, and the like used in the embodiments of the present disclosure do not indicate any order, quantity, or importance, but are only used to distinguish different components. Words of “including” or “comprising” and the like mean that the element or item before the word appears to encompass the element or item listed after the word and equivalents thereof, without excluding other elements or items. Words such as “connected” or “connected” are not limited to physical or mechanical connections, but may include electrical connections, whether direct or indirect. The terms “upper”, “lower”, “left”, “right” and the like are only used for representing the relative position relationship, and when the absolute position of the described object changes, the relative position relationship may also change correspondingly.

As described above, generally, only sparse 3D points can be obtained by using the SLAM technology. However, since the 3D points obtained by using the SLAM technology are sparse, a large number of planes cannot be estimated because there are few 3D points exist. In addition, there are many non-planar areas in the actual scenario, which cannot be estimated through the SLAM technology, and the existence of these cases may cause a problem that a virtual object cannot be placed in an image because a plane corresponding to the virtual object cannot be found.

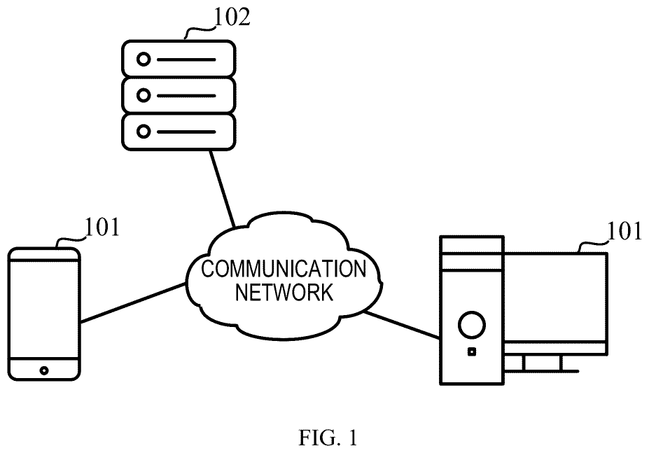

To solve the problem, some embodiments of the present disclosure provide a method for placing a virtual object in a video. Referring to FIG. 1. FIG. 1 is a schematic diagram of an application scenario of a method for placing a virtual object in a video according to an embodiment of the present disclosure. The application scenario includes a terminal device 101 and an augmented reality processing device 102.

In the embodiment of the present disclosure, the terminal device 101 and the augmented reality processing device 102 are functionally differentiated, and FIG. 1 only provides an example of an application scenario. In practical applications, the terminal device 101 and the augmented reality processing device 102 may be two independent physical devices, or may be integrated on a single physical device, and implement interaction with a user and processing of a video at the same time. If the terminal device 101 and the augmented reality processing device 102 are two independent physical devices, the terminal device 101 and the augmented reality processing device 102 may be connected through a wired or wireless communication network.

In the embodiment of the present disclosure, the foregoing terminal device 101 includes, but is not limited to, a desktop computer, a mobile phone, a mobile computer, a tablet computer, a media player, an intelligent wearable device, a personal digital assistant (Personal Digital Assistant, PDA), or another electronic device capable of implementing the foregoing functions. The foregoing terminal device 101 may display, through a display screen, an interactive interface which may interact with a user, thereby providing various augmented reality applications for the user. For example, the user may select a position in each image frame of a video played by the terminal device 101 to place a virtual object.

The augmented reality processing device 102 may be an electronic device with computing capability, and is configured to perform augmented reality processing on an image frame in a video, for example, implementing placement of a virtual object at a position selected by a user.

Based on the foregoing application scenario, some embodiments of the present disclosure provide a method for placing a virtual object in a video, which can accurately determine a plane on which the virtual object is placed, thereby avoiding the problem that the virtual object cannot be placed in the video because the plane corresponding to the virtual object cannot be found. It should be noted that the method may be executed by the augmented reality processing device 102.

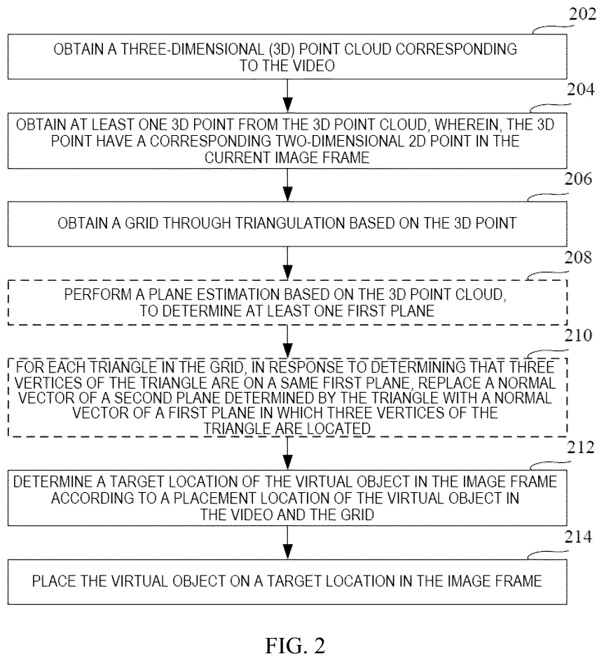

FIG. 2 shows an implementation flow of a method for placing a virtual object in a video according to an embodiment of the present disclosure. As shown in FIG. 2, the method may include the following steps:

At Step 202, obtain a 3D point cloud corresponding to the video.

In the embodiment of the present disclosure, if the user wants to place a virtual object at a certain position of each image frame in a video, the user generally needs to select the virtual object to be placed through the terminal device 101, and select a position on one image frame of the video, where the virtual object is placed in the video. Then, the terminal device 101 generates and sends a virtual object placement request carrying the information to the augmented reality processing device 102, and the augmented reality processing device 102 places the virtual object at a placement position selected by the user in the video. In embodiments of the present disclosure, the virtual object may generally refer to a material such as a picture, a virtual object or a piece of video, etc.

Specifically, in the embodiment of the present disclosure, the placement position of the virtual object in the video may be specifically mapped to a point in each image frame in the video, and may be represented by means of coordinates of pixel points in the image frame.

In the embodiments of the present disclosure, in order to realize the placement of a virtual object in a video, each plane in each image frame in the video needs to be estimated, that is, the plane of each image frame needs to be estimated. In addition, plane estimation generally needs to be implemented based on a 3D point corresponding to the video; therefore, in Step 202, in order to implement placement of a virtual object in the video, a 3D point cloud corresponding to the video is first obtained.

A person skilled in the art may understand that, by using the SLAM technology, 2D points in a two-dimensional (2D) image frame included in a video segment may be mapped to a three-dimensional space, so as to obtain 3D points corresponding to 2D points in the image frame in the three-dimensional space. Further, after the mapping from the 2D point to the 3D point is completed for each of a plurality of 2D images, a global 3D point cloud may be obtained, which is referred to as a 3D point cloud corresponding to a video in the present disclosure.

Thus, it can be seen that the 3D point cloud obtained by the SLAM technology not only comprises various 3D points, but also comprises correspondences between these 3D points and 2D points in various image frames of the video, for example, one 3D point in the 3D point cloud may correspond to one 2D point in a plurality of image frames, etc.

It should be noted that, in addition to the SLAM technology, each 2D point in an image frame in a video may also be mapped to a 3D point in a three-dimensional space by using a pose of a camera for capturing the video.

Further, after the 3D point cloud corresponding to the video is obtained, the following steps are respectively executed for each image frame in the video:
At step 204, obtain a 3D point in the 3D point cloud having a corresponding 2D point in the current image frame.

As mentioned previously, each 3D point in the 3D point cloud corresponding to a video corresponds to a 2D point in at least one image frame of the video. Therefore, in an embodiment of the present disclosure, for one image frame, all 3D points having corresponding 2D points in the image frame may be determined from the 3D point cloud according to corresponding relationships between 3D points in the 3D point cloud and 2D points in each image frame.

At Step 206, obtain a grid through triangulation based on the 3D point.

In some embodiments of the present disclosure, in the foregoing Step 206, the augmented reality processing device 102 may directly use the set of 3D points as a finite point set, and obtain, based on the finite point set, the grid by using a Delaunay triangulation algorithm.

In some other embodiments of the present disclosure, to improve precision of triangulation, in the Step 206, the augmented reality processing device 102 may first determine 2D points corresponding to the 3D points in the current image frame; then, using the described set of 2D points as a finite point set; next, based on the finite point set, obtaining a first grid by means of a Delaunay triangulation algorithm; obtaining, according to the connection relationships between the 2D points in the first grid and the corresponding relationships between the 2D points and the 3D points, connection relationships between the 3D points corresponding to the first grid; finally, a second grid is determined according to the connection relationships between the 3D points, and the determined second grid is used as the grid referred to in Step 206. That is, in the foregoing method, a 2D grid is obtained by performing Delaunay triangulation on a 2D point, and then the obtained 2D grid is mapped to a 3D mesh according to corresponding relationships between the 2D points and the 3D points.

As is known, the above grids should satisfy the following conditions:
(1) Except for the endpoints, none of the points in the finite point set described above is included on the edge in the plane view shown by the grid.
(2) Except for the endpoints, there are no intersecting edges in the plane view of the grid.
(3) All faces in the plane view shown by the described grid are triangles, and the union set of all triangular faces is a convex hull of the described finite point set.

FIG. 3 shows an example of a grid obtained from a finite point set through a Delaunay triangulation algorithm according to an embodiment of the present disclosure. With the Delaunay triangulation algorithm, based on a finite point set shown in the left half part of FIG. 3, a grid shown in the right half part of FIG. 3 may be obtained. As can be seen in FIG. 3, no other points are included on each edge of the plane view shown in the grid except for the endpoints in the grid. Moreover, the edges of the grid do not intersect. Finally, all of the planes shown in the plane view of the grid are triangular.

In the embodiments of the present disclosure, a plurality of triangles can be obtained by means of triangulation, and each triangle may determine a plane; therefore, a plurality of planes included in each image frame can be obtained, thereby effectively solving the problem of a plane that cannot be estimated when plane estimation is performed based on a small number of 3D points, and the problem that some non-planar regions cannot be estimated in an actual scenario.

In addition to the described method for estimating a plane by means of triangulation, in order to further improve the accuracy of plane estimation and avoid the problem that a plane appears uneven due to errors when plane estimation is performed by means of triangulation and the plane is estimated into a plurality of planes, some other embodiments of the present disclosure may further comprise the following steps:

At step 208, perform a plane estimation based on the 3D point cloud, to determine at least one first plane.

In an embodiment of the present disclosure, the above-described augmented reality processing apparatus 102 may perform plane estimation by a random sample consensus algorithm (RANSAC). RANSAC is an algorithm first proposed by Fischer and Bolles in 1981. The algorithm calculates a mathematical model parameter of data according to a set of sample data sets containing abnormal data. Currently, RANSAC algorithms are commonly used to find the best matching model in the matching problem of computer vision. In an embodiment of the present disclosure, the augmented reality processing apparatus 102 may fit a plurality of first planes according to the 3D point cloud image by using the RANSAC algorithm. In this example, the best matching model found by the RANSAC algorithm is a plurality of first planes.

By means of the method, a plurality of first planes can be determined, i.e. parameters of the plurality of first planes and 3D points contained thereon are determined. The parameters of the plane may include various parameters of a plane equation for determining the plane. For example, each plane in the 3D space may be expressed in a form of Ax+By+Cz+D=0, and the plane may be determined by determining the four coefficients A, B, C, and D. Therefore, the parameters of the plane may refer to the four coefficients A, B, C, and D. In addition, the plane expression may also be represented by a normal vector and a distance, and a plane may also be determined by determining the normal vector and the distance of the plane; therefore, the parameters of the plane may also refer to the normal vector and the distance of the plane. It should be noted that the parameters of the planes in the described various forms are consistent in nature, and a plane can be uniquely determined, for example, a normal vector and a distance of the plane can be determined by means of the described four coefficients A, B, C and D; the four coefficients A, B, C, and D may also be obtained by using a normal vector and a distance of a plane.

At step 210, for each triangle in the grid, in response to determining that three vertices of the triangle are on a same first plane, replace normal vector of a second plane determined by the triangle with a normal vector of a first plane in which three vertices of the triangle are located.

Through the foregoing Steps 208 and 210, a triangular plane obtained through triangulation may be fused with a plane obtained through conventional plane estimation, modifying the normal vector of the plane determined by the triangle, with the normal vector of the first plane, when it is determined that the three vertices of the triangle are all on one determined first plane, That is, the problem that a plane which cannot be estimated caused by relatively few 3D points through using a conventional plane estimation method is solved. It also solves the problem of the occurrence of the unevenness in the plane which occurs when one plane is estimated as a plurality of planes caused by the error when the plane is estimated by the described triangulation. Thus, the final plane estimation result is more accurate.

In step 212, determine a target position of the virtual object in the image frame according to a placement location of the virtual object in the video and the grid.

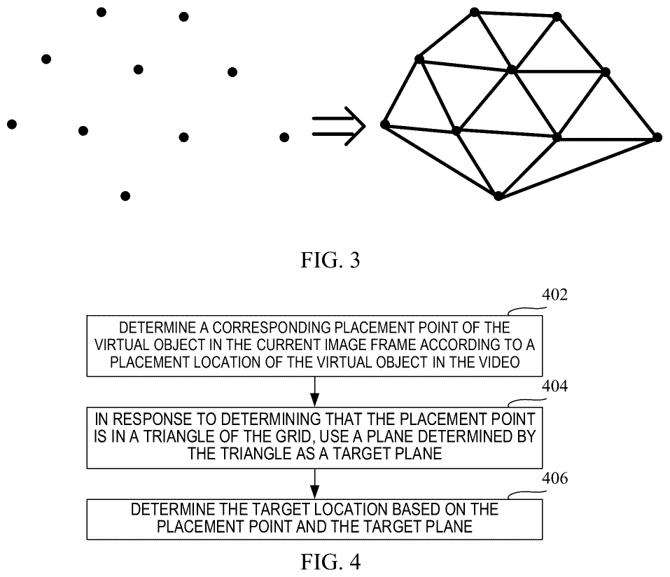

As mentioned above, the placement position of the described virtual object in the described video actually is a point in each image frame in the video. It can be seen by a person skilled in the art that after a user selects a point in a certain image frame of a video, a point corresponding to the point selected by the user in each image frame of the video may be determined by means of a plane tracing technology. Based on the described contents, in the embodiments of the present disclosure, the specific implementation method for determining the target position of the virtual object in the described image frame according to the placement location of the virtual object in the video and the described grid in the described step 212 may be as shown in FIG. 4, and comprises the following steps:
In step 402, determine a corresponding placement point of the virtual object in the current image frame according to a placement position of the virtual object in the video.

As described above, based on the plane tracking technology, a point corresponding to the described placement position in each image frame of the video may be determined based on the placement position of the virtual object in the video (namely, a point selected by the user on one image frame in the video). For convenience of description, in embodiments of the present disclosure, these points are referred to as placement points in the image frame.

In step 404, in response to determining that the placement point is in a triangle of the grid, use a plane determined by the triangle as a target plane.

In step 406, determine the target position based on the placement point and the target plane.

Specifically, in the embodiment of the present disclosure, the determining the target position based on the placement point and the target plane in Step 408 may include:
firstly, obtaining a pose of a camera corresponding to the image frame; secondly, constructing a ray starting from a center point of the camera and passing through the placement point according to the pose of the camera and the placement point; Again, performing a collision detection on the ray and the target plane to determine a collision position; and finally, using the collision position as the target location.

The method can further comprise: if no collision is detected in the process of performing collision detection on the ray and the target plane, the target position cannot be obtained, and thus the placement of the virtual object cannot be completed. At this time, the above-described augmented reality processing apparatus 102 may output information of a failure of a placement of a virtual object.

Further, in some embodiments of the present disclosure, the above step 404 may further comprise: in response to determining that the above placement point is not in any triangle of the above grid, determining that the virtual object placement has failed. In this case, the augmented reality processing device 102 may output information indicating that the placement of the virtual object has failed. For example, the augmented reality processing device 102 may send a response indicating that the virtual object has failed to be placed to the terminal device 101, and the terminal device 101 displays corresponding prompt information.

Further, in other embodiments of the present disclosure, Step 404 may further comprise: selecting a plane closest to the placement point among a plurality of planes determined by all triangles in the grid as the target plane in response to determining that the placement point is missing in any triangle of the grid.

In the embodiments of the present disclosure, the plane closest to the placement point may be determined in the following manners: firstly, for each triangle in the grid, respectively using a plane determined by the triangle as a reference plane, and respectively determining a distance from the placement point to each reference plane; then, selecting a reference plane corresponding to the shortest distance as the target plane.

Specifically, in the foregoing process, the determining a distance between the placement point and a reference plane may include: obtaining a pose of a camera corresponding to the image frame; constructing a ray starting from a center point of the camera and passing through the placement point according to the pose of the camera and the placement point; determining an intersection of the ray with the reference plane; and using a distance from the placement point to an intersection point as a distance from the placement point to the reference plane.

For the method for determining an intersection of the ray with the reference plane, reference may be made to the description in the foregoing embodiments, and no repeated description is provided herein.

In step 214, the virtual object is placed on a target location in the image frame.

It can be seen that, in the embodiment of the present disclosure, a plurality of triangles with the 3D points as the vertices may be obtained through triangulation, each triangle can determine a plane, and therefore, a plurality of planes included in each image frame can be obtained according to the plurality of triangles. Then, the target plane and the target position for the placement of the virtual object are determined therefrom according to the relationship between placement location of the virtual object and the plurality of planes. The above-mentioned method may effectively solve the problem that virtual object placement cannot be completed due to the fact that the plane estimation cannot be completed when plane estimation is performed based on a relatively small number of 3D points and some non-planar areas in an actual scenario cannot be estimated.

It should be noted that the method according to the embodiments of the present disclosure may be executed by a single device, such as a computer or a server. The method in this embodiment may also be applied to a distributed scenario, and multiple devices cooperate with each other to complete the method. In this distributed scenario, one of the multiple devices may execute only one or more steps in the method according to the embodiment of the present invention, and the plurality of devices interact with each other to implement the method.

It should be noted that some embodiments of the present disclosure have been described above, and other embodiments are within the scope of the appended claims. In some cases, the actions or steps recited in the claims may be performed in a different order than in the embodiments described above and still achieve desirable results. In addition, the processes depicted in the figures do not necessarily require the particular order shown, or sequential order, to achieve desirable results. In certain embodiments, multitasking and parallel processing may also or may be advantageous.

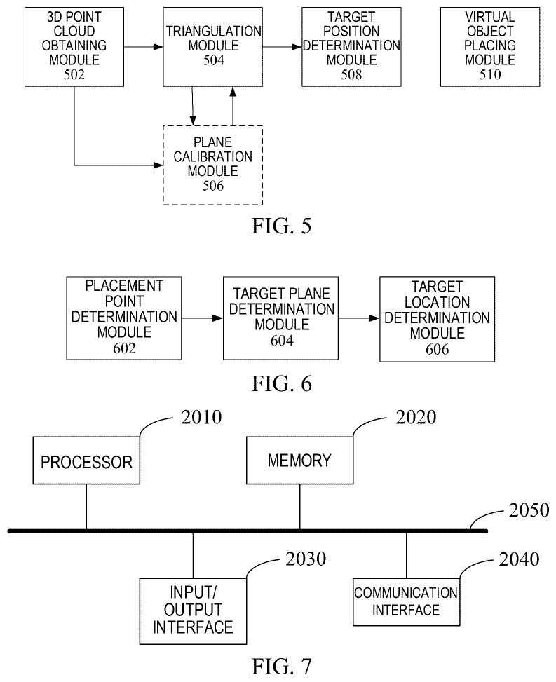

Corresponding to the method for placing a virtual object in a video, the embodiments of the present disclosure further disclose an apparatus for placing a virtual object in a video. FIG. 5 shows an internal structure of an apparatus for placing virtual objects in a video according to an embodiment of the present disclosure. As shown in FIG. 5, the apparatus may include: a 3D point cloud obtaining module 502, a triangulation module 504, a target location determination module 508, and a virtual object placing module 510.

The 3D point cloud obtaining module 502 is configured to obtain a 3D point cloud corresponding to the video.

In the embodiment of the present disclosure, the 3D point cloud obtaining module 502 may directly obtain the 3D point cloud corresponding to the video based on the SLAM technology. Alternatively, the 3D point cloud obtaining module 502 may map 2D points in an image frame in the video to 3D points in a three-dimensional space based on a pose of a camera capturing the video, so as to obtain a 3D point cloud corresponding to the video.

The triangulation module 504 is configured to, obtain, for each image frame in a video, a 3D point in the 3D point cloud having a corresponding two-dimensional 2D point in the image frame, and obtain a grid through triangulation based on the 3D point.

In an embodiment of the present disclosure, for an image frame, the triangulation module 504 may determine all 3D points having corresponding 2D points in the image frame from a 3D point cloud according to corresponding relationships between 3D points in the 3D point cloud and 2D points in each image frame.

In addition, in some embodiments of the present disclosure, the triangulation module 504 may directly use the set of 3D points as a finite point set, and obtain the grid through a Delaunay triangulation algorithm based on the finite point set.

In other embodiments of the present disclosure, in order to improve the accuracy of triangulation, the triangulation module 504 may include the following units:
a 2D point determination unit, configured to determine a 2D point corresponding to the 3D point in the image frame;
a triangulation unit, configured to use the set of 2D points as a finite point set, and obtain, based on the finite point set and by using a Delaunay triangulation algorithm, a first grid;
a grid mapping unit, configured to obtain a connection relationship between the 3D points corresponding to the first grid according to connection relationships between 2D points in the first grid and corresponding relationships between the 2D points and the 3D points; and determine the grid according to connection relationships between the 3D points.

In the embodiments of the present disclosure, a plurality of triangles may be obtained by means of triangulation, and each triangle may determine a plane; therefore, a plurality of planes included in each image frame can be obtained, thereby effectively solving the problem of a plane that cannot be estimated when plane estimation is performed based on a small number of 3D points, and the problem that some non-planar areas cannot be estimated in an actual scenario.

In addition to the described plane estimation method by means of triangulation, in order to further improve the accuracy of plane estimation, to avoid the problem of the occurrence of an unevenness in a plane occurring when one plane is estimated as a plurality of planes by an error when the plane estimation is performed by the described triangulation. In other embodiments of the present disclosure, the apparatus for placing a virtual object in a video can further include a plane calibration module 506, for conducting a plane estimation based on the 3D point cloud, and determining at least one first plane; and for each triangle in the grid, in response to determining that three vertices of a triangle are on a same first plane, replacing the normal vector of the second plane determined by the triangle with the normal vector of the first plane in which the three vertices of the triangle are located.

In the embodiment of the present disclosure, the described plane calibration module 506 can perform plane estimation by means of the RANSAC algorithm, so as to determine a plurality of first planes, i.e. determine parameters of the plurality of first planes and 3D points comprised thereon.

The plane calibration module 506 may combine the triangular plane obtained through triangulation with a plane obtained through conventional plane estimation, calibrating the normal vector of the plane determined by the triangle, with the normal vector of the first plane, when it is determined that the three vertex points of the triangle are all on a determined first plane. That is, the problem that a plane cannot be estimated by using a conventional plane estimation method due to relatively few 3D points is solved. It also solves the problem of the occurrence of the unevenness in the plane which occurs when one plane is estimated as a plurality of planes by the error when the plane is estimated by the described triangulation, Thus, the final plane estimation result is more accurate.

The target location determination module 508 is configured to determine a target location of the virtual object in the image frame according to a placement location of the virtual object in the video and the grid.

Specifically, in some embodiments of the present disclosure, as shown in FIG. 6, the target position determination module 508 may specifically include:
a placement point determination unit 602, configured to determine a corresponding placement point of the virtual object in the image frame according to a placement position of the virtual object in the video;
a target plane determination unit 604, configured to, in response to determining that the placement point is in a triangle of the grid, use a plane determined by the triangle as a target plane; and
a target position determination unit 606, configured to determine the target position based on the placement point and the target plane.

In other embodiments of the present disclosure, the target plane determination unit may be further configured to select a plane closest to the placement point among a plurality of planes determined by all triangles in the grid as the target plane in response to determining that the placement point is missing in any triangle of the grid.

The virtual object placing module 510 is configured to place the virtual object at the target location in the image frame.

For specific implementation of the foregoing modules, reference may be made to the foregoing method and accompanying drawings, and details are not repeatedly described herein. For ease of description, the foregoing apparatus is described by dividing functions into various modules for separate description. Definitely, when the present disclosure is implemented, functions of each module may be implemented in one or more pieces of software and/or hardware.

The apparatus in the described embodiment is used for implementing the corresponding method for placing a virtual object in a video in any one of the described embodiments, and has the beneficial effect of the corresponding method embodiment, which will not be described herein again.

Based on the same inventive concept, corresponding to the method of any of the above embodiments, the present disclosure further provides an electronic device, comprising a memory, a processor and a computer program stored in the memory and operable on the processor, wherein when executing the program, the processor realizes the method for placing a virtual object in a video of any of the above embodiments.

FIG. 7 is a schematic structural diagram of hardware of a more specific electronic device according to this embodiment. The device may include: a processor 2010, a memory 2020, an input/output interface 2030, a communication interface 2040, and a bus 2050. The processor 2010, the memory 2020, the input/output interface 2030, and the communication interface 2040 implement a communication connection between each other inside the device through the bus 2050.

The processor 2010 may be implemented by using a general CPU (Central Processing Unit), a microprocessor, an application specific integrated circuit (Application Specific Integrated Circuit, ASIC), or one or more integrated circuits, and is configured to execute a relevant program, so as to implement the technical solutions provided in the embodiments of the specification.

The memory 2020 may be implemented in the form of a ROM (Read Only Memory, read only memory), a RAM (Random Access Memory, random access memory), a static storage device, and a dynamic storage device. The memory 2020 may store an operating system and other application programs. When the technical solutions provided in the embodiments of the present description are implemented by software or firmware, related program codes are stored in the memory 2020 and invoked and executed by the processor 2010.

The input/output interface 2030 is configured to connect to an input/output module, so as to implement information input and output. The input/output module may be configured in a device (not shown in the figure) as a component, and may also be externally connected to the device to provide a corresponding function. The input device may include a keyboard, a mouse, a touch screen, a microphone, various sensors, and the like, and the output device may include a display, a speaker, a vibrator, an indicator lamp, and the like.

The communications interface 2040 is configured to connect to a communications module (not shown in the figure), so as to implement communication interaction between this device and other devices. The communication module may implement communication in a wired manner (such as a USB and a network cable), and may also implement communication in a wireless manner (such as a mobile network, WIFI, and Bluetooth).

The bus 2050 comprises a path that transfers information between various components of the device, such as the processor 2010, the memory 2020, the input/output interface 2030, and the communication interface 2040.

It should be noted that, although the foregoing device only shows the processor 2010, the memory 2020, the input/output interface 2030, the communications interface 2040, and the bus 2050, in a specific implementation process, the device can further include other components necessary for implementing normal running. In addition, a person skilled in the art may understand that the foregoing device may also only include components necessary for implementing solutions of embodiments of the present specification, and does not necessarily include all components shown in the figure.

The electronic device in the foregoing embodiments is used to implement the corresponding method for placing a virtual object in a video in any one of the foregoing embodiments, and has beneficial effects of the corresponding method embodiments, which are not described herein again.

Based on the same inventive concept, corresponding to the method of any of the above embodiments, the present disclosure further provides a non-transitory computer-readable storage medium, wherein the non-transitory computer-readable storage medium stores computer instructions, and the computer instructions are used for enabling the computer to execute the method for placing a virtual object in a video as described in any of the above embodiments.

The computer readable media of this embodiment, including both persistent and non-persistent, removable and non-removable media, may be any method or technology for storage of information. The information may be computer readable instructions, data structures, modules of a program, or other data. Examples of computer storage media include, but not limited to phase change memory (PRAM), static random access memory (SRAM), dynamic random access memory (DRAM), other types of random access memory (RAM), read-only memory (ROM), electrically erasable programmable read-only memory (EEPROM), flash memory or other memory technology, read-only compact disc read-only memory (CD-ROM), digital versatile discs (DVD) or other optical storage, magnetic cassettes, Magnetic tape magnetic disk storage or other magnetic storage devices, or any other non-transmission medium, may be used to store information that may be accessed by a computing device.

The computer instruction stored in the storage medium of the foregoing embodiment is used to enable the computer to execute the task processing method according to any one of the foregoing embodiments, and has beneficial effects of the corresponding method embodiments, which are not described herein again.

It should be understood by one of ordinary skill in the art that the discussion of any embodiment above is merely exemplary and is not intended to imply that the scope of the present disclosure, including the claims, is limited to these examples; In the concept of the present disclosure, the technical features in the above embodiments or different embodiments may also be combined, the steps may be implemented in any order, and there are many other variations on different aspects of the embodiments of the present disclosure as described above, which are not provided in detail for simplicity.

In addition, well-known power/ground connections to integrated circuit (IC) chips and other components may or may not be shown in the provided drawings for simplicity of illustration and discussion, and so as not to obscure embodiments of the present disclosure. Furthermore, the apparatus may be shown in block diagram form in order to avoid obscuring embodiments of the present disclosure, and this also takes into account the fact that specifics with respect to embodiments of these block diagram apparatus are highly dependent upon the platform on which the embodiments of the present disclosure are to be implemented (i.e., such specifics should be well within purview of those skilled in the art). Where specific details (e. g., circuits) are set forth in order to describe example embodiments of the disclosure, it should be apparent to those skilled in the art that embodiments of the disclosure may be practiced without, or with variation of, these specific details. Therefore, these descriptions should be regarded as illustrative rather than restrictive.

Although the present disclosure has been described in conjunction with specific embodiments of the present disclosure, many alternatives, modifications, and variations of these embodiments will be apparent to those of ordinary skill in the art in light of the foregoing description. For example, other memory architectures (e.g., dynamic RAM (DRAM)) may use the discussed embodiments.

It is intended that embodiments of the present disclosure cover all such alternatives, modifications and variations as belong to the broad scope of the appended claims. Therefore, any omissions, modifications, equivalents and improvements made without departing from the spirit and principle of the embodiments of the present disclosure shall belong to the scope of protection of the present disclosure.

1. A method for placing a virtual object in a video, comprising:
obtaining a three-dimensional 3D point cloud corresponding to the video;
for each image frame in the video, respectively performing:
obtaining a 3D point in the 3D point cloud having a corresponding two-dimensional 2D point in the image frame;
obtaining a grid through triangulation based on the 3D point;
determining a target location of the virtual object in the image frame according to a placement location of the virtual object in the video and the grid; and
placing the virtual object on a target location in the image frame.

2. The method of claim 1, further comprising:
performing a plane estimation based on the 3D point cloud, to determine at least one first plane; and
for each triangle in the grid, in response to determining that three vertices of the triangle are on a same first plane, replacing a normal vector of a second plane determined by the triangle with a normal vector of a first plane in which three vertices of the triangle are located.

3. The method of claim 2, wherein the performing a plane estimation based on the 3D point cloud comprises:
determining the at least one first plane based on the 3D point cloud through performing a plane estimation with a random sample consensus RANSAC algorithm.

4. The method of claim 1, wherein the obtaining a grid through triangulation based on the 3D point comprises:
determining a 2D point corresponding to the 3D point in the image frame;
using the 2D point as a finite point set; and
obtaining a first grid through a Delaunay triangulation algorithm based on the finite point set;
obtaining a connection relationship between the 3D points corresponding to the first grid according to connection relationships between 2D points in the first grid and corresponding relationships between the 2D point and the 3D points; and
determining the grid according to connection relationships between the 3D points.

5. The method of claim 1, wherein the obtaining a grid through triangulation based on the 3D point comprises:
using a set of the 3D points as a finite point set; and
obtaining the grid through a Delaunay triangulation algorithm based on the finite point set.

6. The method of claim 1, wherein the determining a target position of the virtual object in the image frame according to a placement location of the virtual object in the video and the grid comprises:
determining a corresponding placement point of the virtual object in the image frame according to a placement location of the virtual object in the video;
in response to determining that the placement point is in a triangle of the grid, using a plane determined by the triangle as a target plane; and
determining the target position based on the placement point and the target plane.

7. The method of claim 6, wherein the determining the target position based on the placement point and the target plane comprises:
obtaining a pose of a camera corresponding to the image frame;
constructing a ray starting from a center point of the camera and passing through the placement point according to the pose of the camera and the placement point;
performing a collision detection on the ray and the target plane to determine a collision position; and
using the collision position as the target location.

8. The method of claim 7, further comprising: outputting information of a failure of a placement of a virtual object in response to failing to detect a collision position.

9. The method of claim 6, further comprising: outputting information of a failure of a placement of a virtual object in response to determining that the placement point is missing in any triangle of the grid.

10. The method of claim 6, further comprising: selecting a plane closest to the placement point among a plurality of planes determined by all triangles in the grid as the target plane in response to determining that the placement point is missing in any triangle of the grid.

11. The method of claim 10, wherein the selecting, from the grid, a triangle closest to the placement point comprises:
for each triangle in the grid, respectively using a plane determined by the triangle as a reference plane, and respectively determining a distance from the placement point to each reference plane;
selecting a reference plane corresponding to the shortest distance as the target plane.

12. The method of claim 11, wherein the determining a distance from the placement point to the reference plane comprises:
obtaining a pose of a camera corresponding to the image frame;
constructing a ray starting from a center point of the camera and passing through the placement point according to the pose of the camera and the placement point;
determining an intersection of the ray with the reference plane; and
using a distance from the placement point to an intersection point as a distance from the placement point to the reference plane.

13. (canceled)

14. (canceled)

15. (canceled)

16. (canceled)

17. (canceled)

18. (canceled)

19. An electronic device, comprising a memory, a processor and a computer program stored in the memory and executable on the processor, wherein in response to executing the program, the processor realizes the method for placing a virtual object in a video comprising:
obtaining a three-dimensional 3D point cloud corresponding to the video;
for each image frame in the video, respectively performing:
obtaining a 3D point in the 3D point cloud having a corresponding two-dimensional 2D point in the image frame;
obtaining a grid through triangulation based on the 3D point;
determining a target location of the virtual object in the image frame according to a placement location of the virtual object in the video and the grid; and
placing the virtual object on a target location in the image frame.

20. A non-transitory computer readable storage medium storing a computer instruction, wherein the computer instruction is used to enable a computer to execute the method for placing a virtual object in a video comprising:
obtaining a three-dimensional 3D point cloud corresponding to the video;
for each image frame in the video, respectively performing:
obtaining a 3D point in the 3D point cloud having a corresponding two-dimensional 2D point in the image frame;
obtaining a grid through triangulation based on the 3D point;
determining a target location of the virtual object in the image frame according to a placement location of the virtual object in the video and the grid; and
placing the virtual object on a target location in the image frame.

21. (canceled)

22. The electronic device of claim 19, wherein the method further comprises:
performing a plane estimation based on the 3D point cloud, to determine at least one first plane; and
for each triangle in the grid, in response to determining that three vertices of the triangle are on a same first plane, replacing a normal vector of a second plane determined by the triangle with a normal vector of a first plane in which three vertices of the triangle are located.

23. The electronic device of claim 22, wherein the performing a plane estimation based on the 3D point cloud comprises:
determining the at least one first plane based on the 3D point cloud through performing a plane estimation with a random sample consensus RANSAC algorithm.

24. The electronic device of claim 19, wherein the obtaining a grid through triangulation based on the 3D point comprises:
determining a 2D point corresponding to the 3D point in the image frame;
using the 2D point as a finite point set; and
obtaining a first grid through a Delaunay triangulation algorithm based on the finite point set;
obtaining a connection relationship between the 3D points corresponding to the first grid according to connection relationships between 2D points in the first grid and corresponding relationships between the 2D point and the 3D points; and
determining the grid according to connection relationships between the 3D points.

25. The electronic device of claim 19, wherein the obtaining a grid through triangulation based on the 3D point comprises:
using a set of the 3D points as a finite point set; and
obtaining the grid through a Delaunay triangulation algorithm based on the finite point set.

26. The electronic device of claim 19, wherein the determining a target position of the virtual object in the image frame according to a placement location of the virtual object in the video and the grid comprises:
determining a corresponding placement point of the virtual object in the image frame according to a placement location of the virtual object in the video;
in response to determining that the placement point is in a triangle of the grid, using a plane determined by the triangle as a target plane; and
determining the target position based on the placement point and the target plane.

27. The electronic device of claim 26, wherein the determining the target position based on the placement point and the target plane comprises:
obtaining a pose of a camera corresponding to the image frame;
constructing a ray starting from a center point of the camera and passing through the placement point according to the pose of the camera and the placement point;
performing a collision detection on the ray and the target plane to determine a collision position; and
using the collision position as the target location.
